(19) United States
(12) Patent Application Publication
(10) Pub. No.: US 2014/0244209 A1
(43) Pub. Date: Aug. 28, 2014

(54) Systems and Methods for Activity Recognition Training

(71) Applicant: InvenSense, Incorporated, San Jose, CA (US)

(72) Inventors: Jonathan E. Lee, Fremont, CA (US); Karthik Katingari, Milpitas, CA (US)

(73) Assignee: InvenSense, Incorporated, San Jose, CA (US)

(21) Appl. No.: 14/169,782

(22) Filed: Jan. 31, 2014

Related U.S. Application Data
(60) Provisional application No. 61/768,236, filed on Feb. 22, 2013.

(51) Int. Cl. G01D 21/00

(52) U.S. Cl. CPC G01D 21/00
USPC 702/150

(57) ABSTRACT

Systems and methods are disclosed for classifying an activity. A sensor tracks motion by a user and a classifier recognizes data output sensor as corresponding to an activity. The classifier may be trained or otherwise modified using received information, which may include data from the sensor or information from an external source, such as a remotely maintained database. The device may update a local or remote database using sensor data when in a training mode. The training mode may be implemented automatically when there is sufficient confidence in the activity identification or manually in response to a user input.

### CROSS-REFERENCE TO RELATED APPLICATION

This application claims priority and benefit of U.S. Provisional Patent Application No. 61/764,236, filed on Feb. 22, 2013, entitled “ACTIVITY RECOGNITION DEPLOYED TRAINING,” which is incorporated herein by reference in its entirety.

### FIELD OF THE PRESENT DISCLOSURE

This disclosure generally relates to utilizing data from a device receiving sensor data and more specifically to classifying an activity utilizing such a device.

### BACKGROUND

The development of microelectromechanical systems (MEMS) has enabled the incorporation of a wide variety of sensors into mobile devices, such as cell phones, laptops, tablets, gaming devices and other portable, electronic devices. Non-limiting examples of sensors include motion or environmental sensors, such as an accelerometer, a gyroscope, a magnetometer, a pressure sensor, a microphone, a proximity sensor, an ambient light sensor, an infrared sensor, and the like. Further, sensor fusion processing may be performed to combine the data from a plurality of sensors to provide an improved characterization of the device's motion or orientation.

A wide variety of applications have been developed to utilize the availability of such sensor data. For example, sensor data may be employed to classify an activity in which the user of the device may be engaged. The device may be worn or otherwise carried by the user such that a pattern of data output by one or more sensors may be analyzed to be correlated with an activity. Upon recognition of such a pattern, the behavior of the device or another device receiving sensor output from the device may be adjusted in any suitable manner depending on the type of activity recognized. As one of skill in the art will recognize, a wide variety of responses may be employed by the device, ranging from counting calories when the user is exercising to disabling texting ability when the user is driving.

In light of these applications, it would be desirable to provide systems and methods for classifying activities that may be trained. For example, it would be desirable to improve the accuracy with which known activities are recognized. Further, it would also be desirable to facilitate the recognition of new activities, allowing the device to respond in appropriate manners. This disclosure satisfies these and other goals, as will be appreciated in view of the following discussion.

### SUMMARY

As will be described in detail below, this disclosure includes a system for classifying an activity that includes at least one sensor to track motion by a user and a classifier to recognize a first pattern of data output by the at least one sensor as corresponding to a first activity, such that the classifier may be modified by received information. The classifier may include a database configured to correlate sensor data with the first activity. The classifier may also include an algorithm configured to identify the first activity based, at least in part, on the first pattern of data.

In an embodiment, the received information may be data output by the at least one sensor. Alternatively or in addition, the received information may be information from art external source.

In one aspect, the first activity may be art existing activity.

In another aspect, the first activity may be a new activity.

In an embodiment, the classifier may be modified by data output by the at least one sensor based, at least in part, on a comparison of sensor data to a confidence threshold. Alternatively or in addition, the classifier may be modified by data output by the at least one sensor based, at least in part, on a user input.

In one aspect, the database may be maintained remotely. Further, the database may be an aggregation of data from multiple users.

In another aspect, the database is maintained locally.

In one embodiment, the at least one sensor may be coupled to the classifier by a wireless interface.

In another embodiment, the at least one sensor may be coupled to the classifier by a wired interface. Further, the sensor and the classifier may be integrated into the same device. As desired, the sensor and the classifier may be integrated into the same package. Still further, the sensor and the classifier may be integrated into the same chip.

In one aspect, the sensor may include a sensor selected from the group consisting of an accelerometer, a gyroscope, a pressure sensor, a microphone, and a magnetometer.

In one aspect, the pattern of data may correspond to an activity including walking, running, biking, swimming, rowing, skiing, stationary exercising or driving.

This disclosure also includes a method for recognizing a first activity that may involve obtaining data from at least one sensor associated with a user, performing classification routine to identify a first pattern of data obtained from the at least one sensor as corresponding to the first activity, and modifying the classification routine based, at least in part, on received information.

In one aspect, the classification routine may employ a database configured to correlate sensor data with the first activity.

In one aspect, the classification routine may employ an algorithm configured to identify the first activity based, at least in part, on the first pattern of data.

Further, the classification routine may be modified using data output by the at least one sensor. Alternatively or in addition, the classification routine may be modified using information from an external source.

In one aspect, the first activity may be an existing activity.

In another aspect, the first activity may be a new activity.

In an embodiment, the method may also include comparing the sensor data to a confidence threshold, wherein the classification routine is modified based, at least in part, on the comparison.

In an embodiment, the classification routine may be modified by data output by the at least one sensor based, at least in part, on a user input.

Further, in embodiments wherein the database is maintained remotely, the method may also include uploading sensor data to a server. As desired, the method may include aggregating data from multiple users in the database.

In another aspect, the database may be maintained locally.

In one embodiment, the method may include coupling the at least one sensor to a device configured to perform the classification routine with a wired interface.

In another embodiment, the method may include coupling the at least one sensor to a device configured to perform the classification routine with a wireless interface.

In one aspect, the sensor may include a sensor selected from the group consisting of an accelerometer, a gyroscope, a pressure sensor, a microphone, and a magnetometer.

In one aspect, the pattern of data may correspond to an activity including walking, running, biking, swimming, rowing, skiing, stationary exercising or driving.

### BRIEF DESCRIPTION OF THE DRAWINGS

FIG. 1 is schematic diagram of an activity classification device according to an embodiment.

FIG. 2 is flowchart showing a routine for training a device to classify an activity according to an embodiment.

FIG. 3 is flowchart showing a routine for updating a database for classifying an activity according to an embodiment.

FIG. 4 is flowchart showing a routine for updating a device for classifying an activity according to an embodiment.

FIG. 5 is schematic diagram of an activity classification system according to an embodiment.

FIG. 6 is schematic diagram of a device and wearable sensor for activity classification device according to an embodiment.

FIG. 7 is schematic diagram of a device and wearable sensor for activity classification device according to another embodiment.

FIG. 8 is a flowchart showing a routine for updating a remote database with sensor data according to an embodiment.

### DETAILED DESCRIPTION

At the outset, it is to be understood that this disclosure is not limited to Particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may he used with respect to the accompanying drawings or chip embodiments. These and similar directional terms should not be construed to limit the scope of the disclosure in any manner.

In this specification and in the claims, h will he understood that when an element is referred to as being “connected to” or “coupled to” another element, it can be directly connected or coupled to the other element or intervening elements may he present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should he borne in mind, however, that all of these and similar terms are to he associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS cap provides mechanical support for the MEMS structure. The MEMS structural layer is attached to the MEMS cap. The MEMS cap is also referred to as handle substrate or handle wafer. In the described embodiments, an electronic device incorporating a sensor may employ a motion tracking module also referred to as Motion Processing Unit (MPU) that includes at least one sensor in addition to electronic circuits. The sensor, such as a gyroscope, a compass, a magnetometer, an accelerometer, a microphone, a pressure sensor, a proximity sensor, or an ambient light sensor, among others known in the art, are contemplated. Some embodiments include accelerometer, gyroscope, and magnetometer, which each provide a measurement along three axes that are orthogonal relative to each other referred to as a 9-axis device. Other embodiments may not include all the sensors or may provide measurements along one or more axes. The sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package, integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data refers to processed raw data. Processing may include applying a sensor fusion algorithm or applying any other algorithm. In the case of a sensor fusion algorithm, data from one or more sensors may be combined to provide an orientation of the device. In the described embodiments, a MPU may include processors, memory, control logic and sensors among structures.

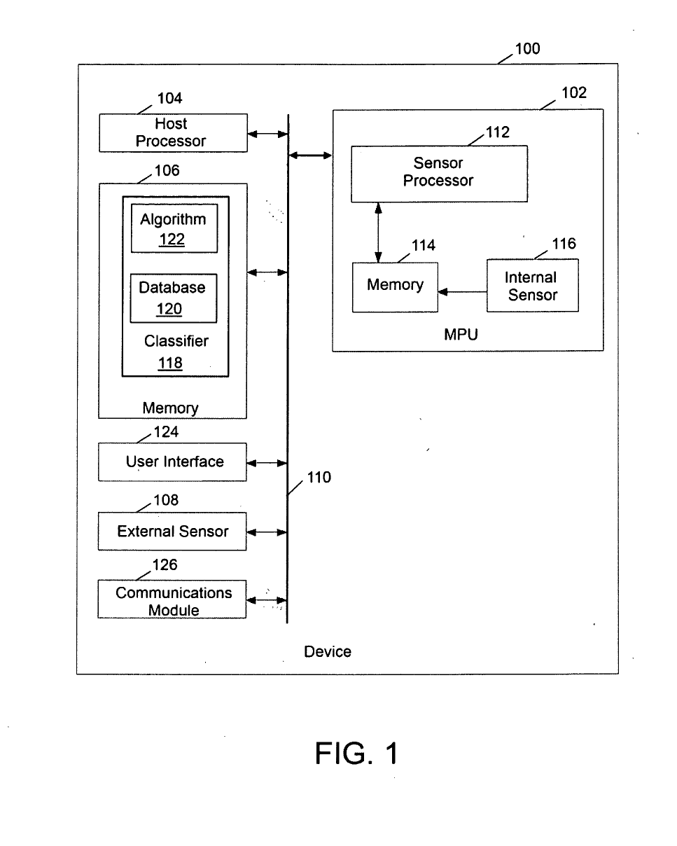

Details regarding one embodiment of a mobile electronic device 100 including features of this disclosure are depicted as high level schematic blocks in FIG. 1. As will be appreciated, device 100 may be implemented as a device or apparatus, such as a handheld device that can be moved in space by a user and its motion and/or orientation in space therefore sensed. For example, such a handheld device may be a mobile phone (e.g., cellular phone, a phone running on a local network, or any other telephone handset), wired telephone (e.g., a phone attached by a wire), personal digital assistant (PDA), video game player, video game controller, navigation device, mobile internet device (MID), personal navigation device (PND), digital still camera, digital video camera, binoculars, telephoto lens, portable music, video, or media player, remote control, or other handheld device, or a combination of one or more of these devices.

In some embodiments, device 100 may be a self-contained device that includes its own display and other output devices in addition to input devices as described below. However, in other embodiments, device 100 may function in conjunction with a non-portable device such as a desktop computer, electronic tabletop device, server computer, etc. which can communicate with the device 100, e.g., via network connections. The device may be capable of communicating via a wired connection using any type of wire-based communication protocol (e.g., serial transmissions, parallel transmissions, packet-based data communications), wireless connection (e.g., electromagnetic radiation, infrared radiation or other wireless technology), or a combination of one or more wired connections and one or more wireless connections.

As shown, device 100 includes MPU 102, host processor 104, host memory 106, and external sensor 108. Host processor 104 may be configured to perform the various computations and operations involved with the general function of device 100. Host processor 104 may be coupled to MPU 102 through bus 110, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent. Host memory 106 may include programs, drivers or other data that utilize information provided by MPU 102. Exemplary details regarding suitable configurations of host processor 104 and MPU 102 may be found in co-pending, commonly owned U.S. patent application Ser. No. 12/106,921, filed Apr. 21, 2008, which is hereby incorporated by reference in its entirety.

In this embodiment, MPU 102 is shown to include sensor processor 112, memory 114 and internal sensor 116. Memory 114 may store algorithms, routines or other instructions for processing data output by sensor 116 or sensor 108 as well as raw data and motion data. Internal sensor 116 may include one or more sensors, such as accelerometers, gyroscopes, magnetometers, pressure sensors, microphones and other sensors. Likewise, external sensor 108 may include one or more sensors, such as accelerometers, gyroscopes, magnetometers, pressure sensors, microphones, proximity, and ambient light sensors, and temperature sensors among others sensors. As used herein, an internal sensor refers to a sensor implemented using the MEMS techniques described above for integration with an MPU into a single chip. Similarly, an external sensor as used herein refers to a sensor carried on-board the device that is not integrated into a MPU.

In some embodiments, the sensor processor 112 and internal sensor 116 are formed on different chips and in other embodiments they reside on the same chip. In yet other embodiments, a sensor fusion algorithm that is employed in calculating orientation of device is performed externally to the sensor processor 112 and MPU 102, such as by host processor 104. In still other embodiments, the sensor fusion is performed by MPU 102. More generally, device 100 incorporates MPU 102 as well as host processor 104 and host memory 106 in this embodiment.

As will be appreciated, host processor 104 and/or sensor processor 112 may be one or more microprocessors, central processing units (CPUs), or other processors which run software programs for device 100 or for other applications related to the functionality of device 100. For example, different software application programs such as menu navigation software, games, camera function control, navigation software, and phone or a wide variety of other software and functional interfaces can be provided. In some embodiments, multiple different applications can be provided on a single device 100, and in some of those embodiments, multiple applications can run simultaneously on the device 100. In some embodiments, host processor 104 implements multiple different operating modes on device 100, each mode allowing a different set of applications to be used on the device and a different set of activities to be classified. As used herein, unless otherwise specifically stated, a “set” of items means one item, or any combination of two or more of the items.

Multiple layers of software can be provided on a computer readable medium such as electronic memory or other storage medium such as hard disk, optical disk, flash drive, etc., for use with host processor 104 and sensor processor 112. For example, an operating system layer can be provided for device 100 to control and manage system resources in real time, enable functions of application software and other layers, and interface application programs with other software and functions of device 100. A motion algorithm layer can provide motion algorithms that provide lower-level processing for raw sensor data provided from the motion sensors and other sensors, such as internal sensor 116 and/or external sensor 108. Further, a sensor device driver layer may provide a software interface to the hardware sensors of device 100.

Some or all of these layers can be provided in host memory 106 for access by host processor 104, in memory 114 for access by sensor processor 112, or in any other suitable architecture. For example, in some embodiments, host processor 104 may implement classifier 118 for performing activity recognition based on sensor inputs, such as sensor data from internal sensor 116 as received from MPU 102 and/or external sensor 108. In other embodiments, as will be described below, other divisions of processing may be apportioned between the sensor processor 112 and host processor 104 as is appropriate for the applications and/or hardware used, where some of the layers (such as lower level software layers) are provided in MPU 102. As will be described below, classifier 118 may be used to identify patterns of data that correspond to a variety of activities, including walking, running, biking, swimming, rowing, skiing, stationary exercising (e.g. using an eliptical machines, treadmill or similar equipment), driving and others. Further, classifier 118 may he trained or otherwise modified to identify a new activity or to provide improved accuracy in recognizing an existing activity.

Classifier 118 may include software code for, but not limited to activity classification. In this embodiment, classifier 118 includes database 120 for storing and organizing sensor data that may be correlated with one or more activities and algorithm 122, which may be one or more algorithms configured to process sensor data in order to identify a corresponding activity. In one aspect, algorithm 122 may be implemented as a decision tree, such as a binary decision tree, an incremental decision tree, an alternating decision tree, or the like. Exemplary details regarding suitable techniques for activity classification are described in co-pending, commonly owned U.S. patent application Ser. No. 13/648,963, filed Oct. 10, 2012, which is hereby incorporated by reference in their entirety.

In other embodiments, classifier 118 may be implemented using any other desired functional constructs configured to recognize a pattern of sensor data as corresponding to a physical activity. A system that utilizes classifier 118 in accordance with the present disclosure may take the form of an entirely hardware implementation, an entirely software implementation, or an implementation containing both hardware and software elements. In one implementation, classifier 118 is implemented in software, which includes, but is not limited to, application software, firmware, resident software, microcode, etc. Furthermore, classifier 118 may take the form of a computer program product accessible from a computer-usable or computer-readable medium providing program code for use by or in connection with a computer or any instruction execution system. For the purposes of this description, a computer-usable or computer-readable medium may be any apparatus that can contain, store, communicate, propagate, or transport the program for use by or in connection with the instruction execution system, apparatus, or device. Thus, in an embodiment, device 100 includes any combination of sensors, such as an accelerometer, gyroscope, temperature sensor, pressure sensor, magnetometer, or microphone, and an algorithm for classifying an activity based on features derived from inertial or other sensor data, and the ability to continually report an activity derived from physical activity. A system in accordance with an embodiment may rely on multiple sensors and an activity classification algorithm in order to improve accuracy of the activity recognition results.

Device 100 may also include user interface 124 which provides mechanisms for effecting input and/or output to a user, such as a display screen, audio speakers, buttons, switches, a touch screen, a joystick, a trackball, a mouse, a slider, a knob, a printer, a scanner, a camera, or any other similar components. Further, device 100 may include one or more communication modules 126 for establishing a communications link, which may employ any desired wired or wireless protocol, including without limitation WiFi®, cellular-based mobile phone protocols such as long term evolution (LTE), BLUETOOTH®, ZigBee®, ANT, Ethernet, peripheral component interconnect express (PCIe) bus, Inter-Integrated Circuit (I2C) bus, universal serial bus (USB), universal asynchronous receiver/transmitter (UART) serial bus, advanced microcontroller bus architecture (AMBA) interface, serial digital input output (SDIO) bus and the like. As will be described below, communications module 126 may be configured to receive sensor data from a remote sensor. Alternatively or in addition, communications module 126 may also provide uplink capabilities for transmitting sensor data that has been correlated with an activity to a remote data base or downlink capabilities for receiving updated information for classifier 118, such as information that may be used to modify database 120 or update an algorithm 122.

Thus, an activity recognition system according to this disclosure may include device 100, such that classifier 118 utilizes data output by at least one of external sensor 108 and internal sensor 116 to recognize a pattern of data as corresponding to an activity. As will be described below, performance of classifier 118 may be improved by training after device 100 is deployed. Classifier 118 may be modified by information received from a variety of sources. In one aspect, classifier 118 may be modified by sensor data output from external sensor 108 or internal sensor 116 after an activity has been identified or in response to user input indicating that device 100 is being employed in an activity. Thus, database 120 and/or algorithm 122 may be updated to reflect sensor data that is particular to the way the user engages in the activity, which may correspondingly improve the accuracy of identification. In another aspect, classifier 118 may be modified by information received from an external source, such as a remote database. Similarly, database 120 and/or algorithm 122 may be updated using the received information to improve the accuracy of identifying existing activities or to recognize anew activity. These aspects are described in further detail below.

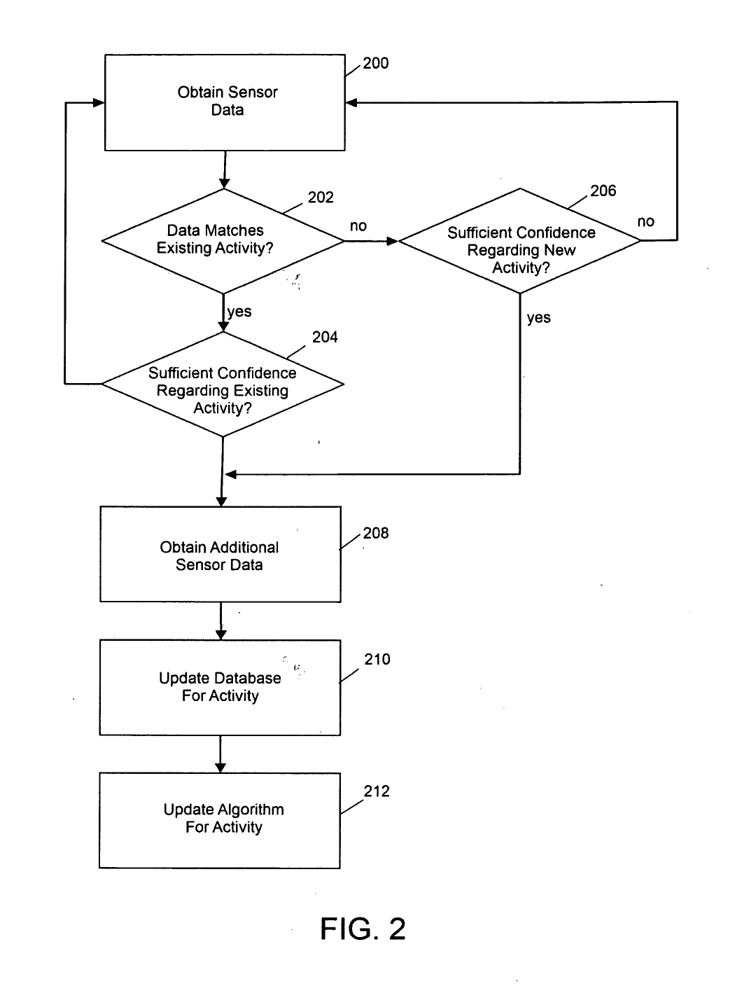

To help illustrate aspects of this disclosure with respect to device 100, FIG. 2 depicts a flowchart showing a process for classifying an activity. Beginning with 200, device 100 ma),' obtain sensor data from any suitable source, including internal sensor 116, external sensor 108 or a remote sensor using communications module 126. Further, the sensor data may be raw, subject to sensor fusion, or otherwise processed as desired. In 202, classifier 202 determines whether the obtained sensor data matches a pattern corresponding to an activity. If a pattern is matched, classifier 118 may further determine in 204 whether the activity has been recognized with sufficient confidence to perform a modification. The confidence determination may be made automatically, such as by determining whether the degree to which the pattern matches the sensor data surpasses a suitable threshold. The rate at which different activities are recognized may also be used to assess the confidence of the determination. The confidence determination may also be made in response to a user input, such as the user engaging a training mode that explicitly informs device 100 that sensor data should be correlated to an identified activity. If there is insufficient confidence, the routine may return to 200 and further sensor data may be obtained. If a pattern was not matched in 202, the routine branches to 206 where a similar confidence determination may be made with regard to anew activity. For example, if the sensor data is well grouped but the pattern is sufficiently different from known activities, classifier 118 may enter a training mode to correlate sensor data with a new activity. Further, the user may also explicitly engage a training mode while engaging in a new activity, in either case, it may be desirable to prompt the user to identify the new activity, if there is insufficient confidence in 206, again the routine may return to 200.

Upon a determination of sufficient confidence in either 204 or 206, the routine then flows to 208 such that additional sensor data is obtained and correlated with the identified activity. Subsequently, the sensor data correlated with the identified activity may be used to update database 120 in 210. In some embodiments, the updated database may be used to update at least one algorithm 122 that is configured to identify the activity. As will be described below, aspects of 210 and 212 may be performed at remote location, with any necessary data exchanged using communications module 126.

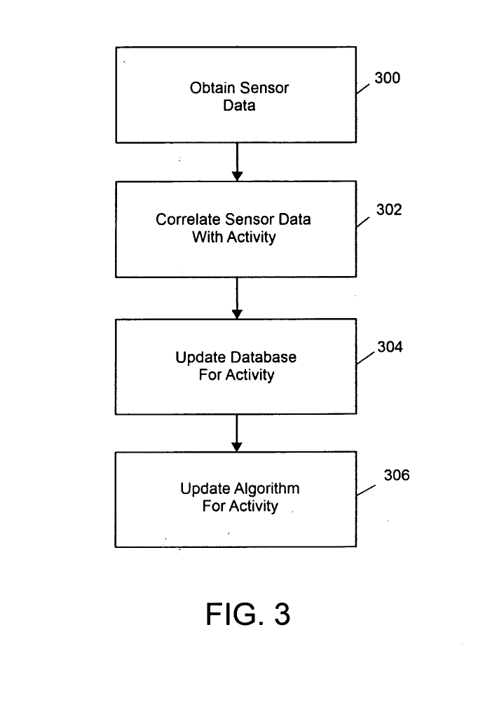

Next, FIG. 3 depicts a flowchart showing a routine that may be performed by device 100 to locally modify classifier 118 in response to sensor data to improve activity classification. In 300, device 100 may obtain sensor data from any source as described above. In 302, classifier 118 may correlate the sensor data with an activity. The correlation may be automatic based on the degree to which the sensor data matches a known pattern or may be in response to user input. The sensor data may then be used to update database 120 in 304. Further, classifier 118 may use the updated database to modify or create an algorithm 122 for identifying the activity.

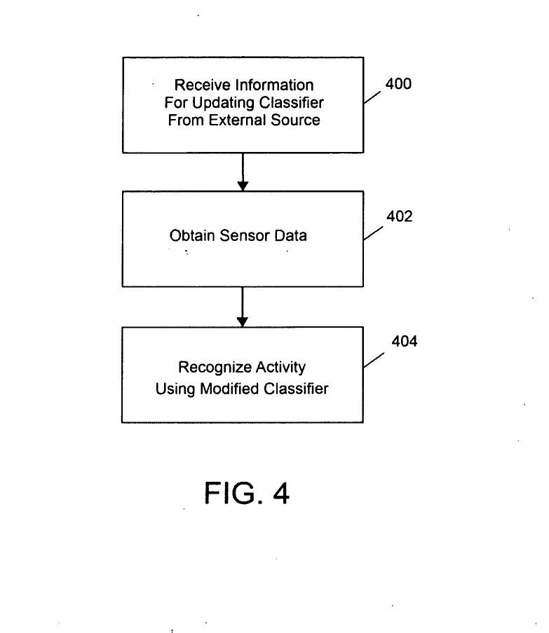

Turning now to FIG. 4, a flowchart is shown that represent a routine for updating device 100 using information received from an external source. Beginning with 400, device 100 may receive information from an external source, such as by using communications module 126. In this embodiment, the information may be used to update database 120 and/or algorithms 122. Subsequent, device 100 may obtain sensor data in 402, again from any suitable source, and then apply modified classifier 118 to recognize an activity corresponding to the obtained sensor data.

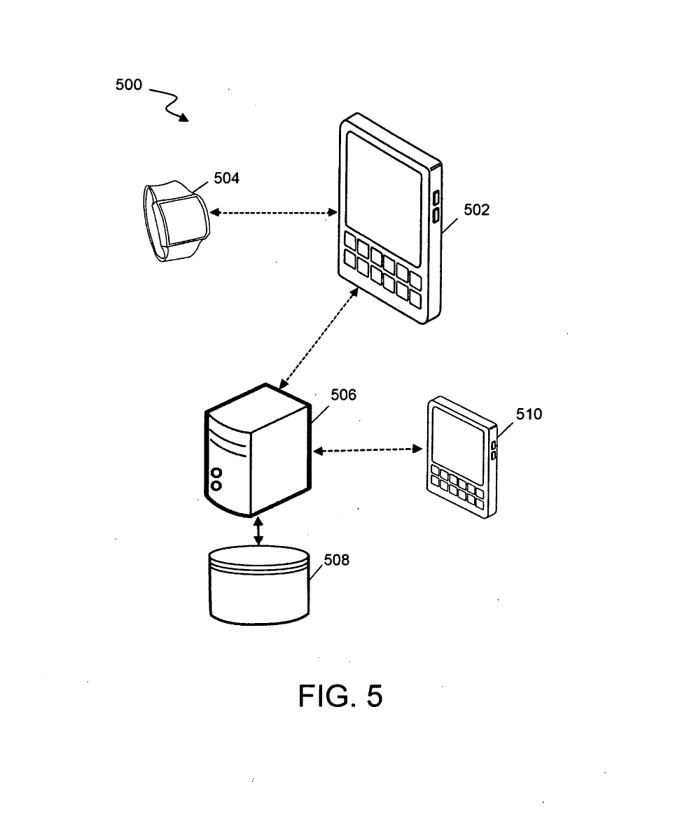

As will be recognized, various aspects of the activity classification system of this disclosure may be implemented in different locations. For example, FIG. 5 depicts system 500 in which a user primary interacts with device 502, which may be a mobile electronic device such as a phone, tablet or other similar device as discussed above. Device 502 may receive sensor data from a wearable sensor 504, such as watch, another wearable sensor, or any other remote source of sensor data. Multiple sources of sensor data may be used as desired, in turn, device 502 may communicate with remote server 506 which maintains database 508 for correlating sensor data with one or more activities. In one aspect, server 506 may perform aspects described above with regard to classifier 118, such as determining a degree of confidence in the identification of existing or new activities, updating database 508 with sensor data received from device 502, updating or creating algorithms configured to recognize an activity using the updated database, and other corresponding activities. In another aspect, server 506 may receive sensor data from other user devices, such as device 510.

As will be recognized, aggregation of sensor data received from additional sources may be used to improve activity classification. As desired, sensor data specific to one user may be employed to tailor the performance of device 502 to that individual sensor data received from a plurality of source may be used to provide a more universal classification of activities or to identify new activities. Device 502 may also be configured to upload demographic information and other details specific to the user t may be used in maintaining database 508. Communications between device 502, wearable sensor 504, server 506 and database 508 may be implemented using any desired wired or wireless protocol as described above. For example, it may be desirable to use a shorter range, low power communication protocol such as BLUETOOTH®, ZigBec®, ANT or a wired connection between device 502 and watch 504 while employing a longer range communication protocol, such as a transmission control protocol, internet protocol (TCP/IP) packet-based communication, accessed using a wireless local area network (WLAN), cell phone protocol or the like. In general, system 500 may embody aspects of a networked or distributed computing environment. Devices 502 and 510, wearable sensor 504 and server 506 may communicate either directly or indirectly, such as through multiple interconnected networks. As will be appreciated a variety of systems, components, and network configurations, topologies and infrastructures, such as client/server, peer-to-peer, or hybrid architectures, may be employed to support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

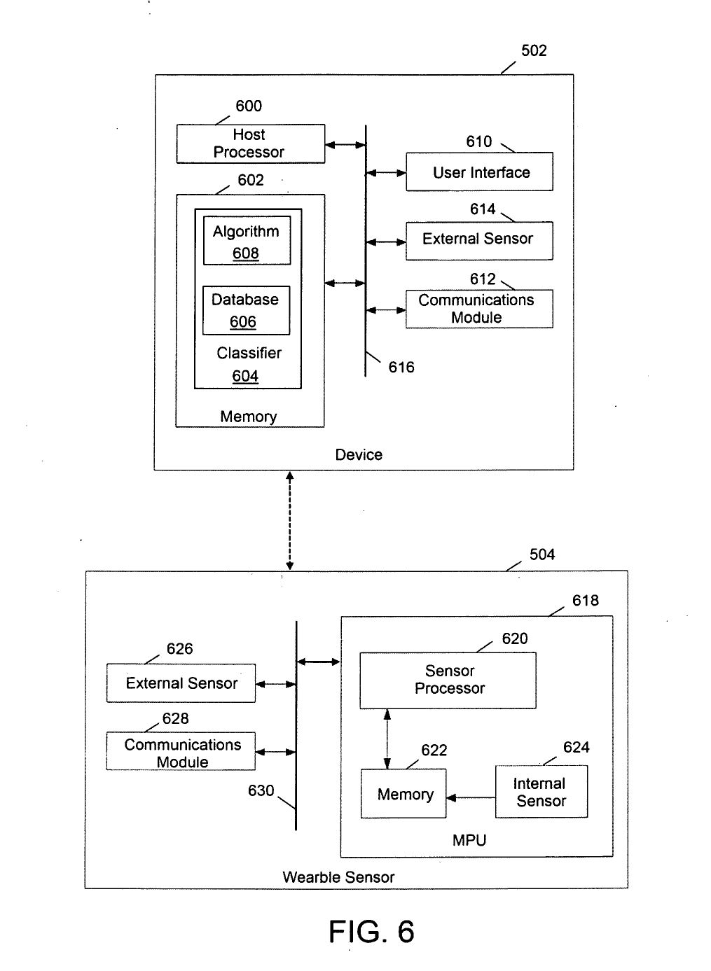

Details regarding one embodiment of device 502 and wearable sensor 504 are shown as a high level schematic diagram in FIG. 6. Device 502 and wearable sensor may include the components generally similar to those described above with regard to FIG. 1. For example, device 502 may include host processor 600 and host memory 602, with classifier 604 that implements database 606 and one or more algorithms 608. Device 502 may also have user interface components 610, at least one communications module 612, and, if desired, an external sensor 614 that is on-board device 502. The components may be coupled by bus 616. Device 502 may receive sensor data from wearable sensor 504, which may include MPU 618, having sensor processor 620, memory 622 and internal sensor 624. Alternatively or in addition, wearable sensor 504 may have an external sensor 626 that may output raw sensor data. MPU 618 and/or external sensor 626 may be coupled to communications module 628 using bus 630. A link between communications module 62.8 and communications module 612 may be used to provide classifier 604 with sensor data. Device 502 may also use communications module 612, or another suitable configured communications module, to upload sensor data to server 506 and/or to download information for updating classifier 604.

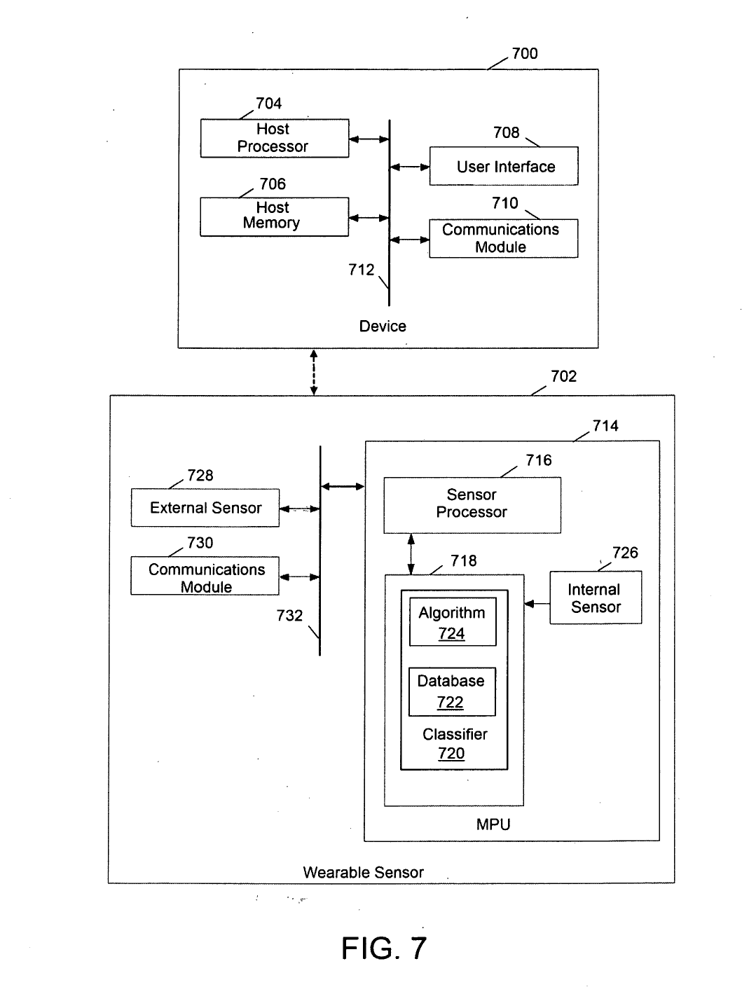

Another embodiment of system 500 is shown in FIG. 7, with device 700 functioning in the role of device 502 to bridge communications between wearable sensor 702, functioning in the role of wearable sensor 504, and server 506. For example, device 700 may generally include host processor 704, memory 706, user interface 708 and communications module 710 interfaced over bus 712. In this embodiment, wearable sensor 702 includes MPU 714, with sensor processor 716 and memory 718. In this embodiment, classifier 720 is implemented in memory 718, although it may be implemented in other locations, such by using a host processor/memory (not shown). Classifier 720 may include database 722 and algorithms 724 as described above. Classifier 720 may receive sensor data from internal sensor 726 or external sensor 728, as desired, and may communicate with device 700 using communications module 730. The components of wearable sensor 702 may be interfaced using bus 732. As will be appreciated, wearable sensor 702 performs the activity classification in this embodiment. Device 700 may receive the classification information for use by applications running on host processor 704 and provides a communication bridge to server 506, such that wearable sensor 702 may upload sensor data or download information for modifying classifier 720, as desired. In this embodiment, wearable sensor 702 may be configured to provide activity classification information to one or more device in addition to device 700.

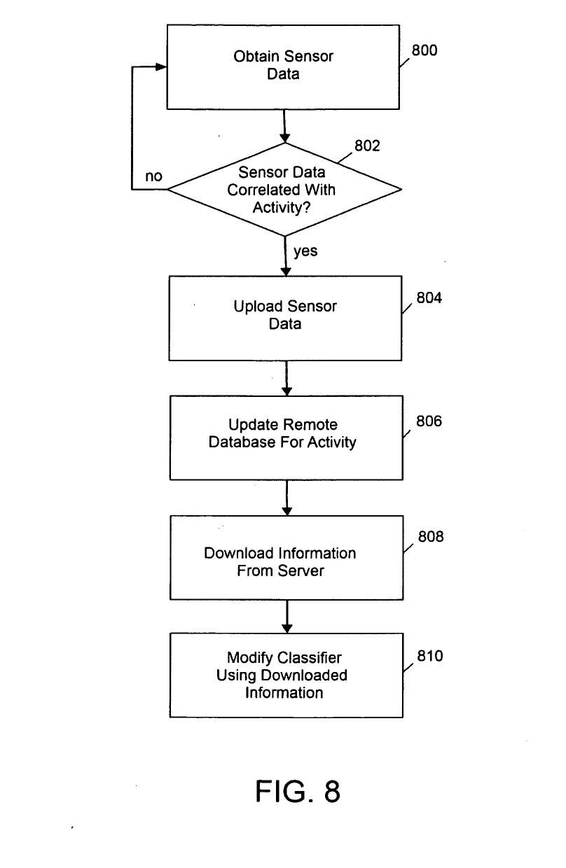

To help illustrate aspects of this disclosure with respect to system 500, FIG. 8 depicts a flowchart showing a process for updating database 508 with sensor data for classifying an activity. Although aspects are described with respect to the embodiment shown in FIG. 6, one of skill in the art will recognize that a similar process may used for the embodiment in FIG. 7, with appropriate substitutions for the different locations of certain functional elements. Likewise, other embodiments may also be employed that provide other divisions of functionality between a wearable sensor, a user device and a remote server. Beginning with 800, device 502 may obtain sensor data from any suitable source, such as from wearable sensor 504. In 802, classifier 604 may determine if the sensor data is sufficiently correlated with an activity. Any of the techniques described above may be used, including determining the degree to which the sensor data matches a pattern and/or receiving user input that indicates a training mode determines whether the obtained sensor data matches a pattern corresponding to an activity. If the sensor data is insufficiently correlated, the routine may return to 800. Otherwise, device 502 may upload sensor data to server 506 in 804 using communications module 612. Server 506 may update database 508 with the uploaded sensor data in 806. As described above, user details may be included with the sensor data to facilitate proper correlation of the data with one or more activities. Next, server 506 may download information associated with the updated database in 808. In some embodiments, this may include information used by device 502 to update local database 606 or may include information for adding or updating one or more algorithms 608. Correspondingly, in 810 device 502 may modify classifier 604 using the downloaded information so that classifier 604 may subsequently be used to identify an activity in a desired manner, such as with more accuracy.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. An activity recognition system comprising:
at least one sensor configured to track motion by a user; and
a classifier configured to recognize a first pattern of data output by the at least one sensor as corresponding to a first activity;
wherein the classifier is configured to he modified by received information.

2. The activity recognition system of claim 1, wherein the classifier comprises a database configured to correlate sensor data with the first activity.

3. The activity recognition system of claim 1, wherein the classifier comprises an algorithm configured to identify the first activity based, at least in part, on the first pattern of data.

4. The activity recognition system of claim 1, wherein the received information comprises data output by the at least one sensor.

5. The activity recognition system of claim 1, wherein the received information comprises information from an external source.

6. The system of claim 1, wherein the first activity comprises an existing activity.

7. The system of claim 1, wherein the first activity comprises a new activity.

8. The system of claim 1, wherein the classifier is configured to he modified by data output by the at least one sensor based, at least in part, on a comparison of sensor data to a confidence threshold.

9. The system of claim 1, wherein the classifier is configured to be modified by data output by the at least one sensor based, at least in part, on a user input.

10. The system of claim 2, wherein the database is maintained remotely.

11. The system of claim 10, wherein the database comprises an aggregation of data from multiple users.

12. The system of claim 2, wherein the database is maintained locally.

13. The system of claim 1, wherein the at least one sensor is coupled to the classifier by a wireless interface.

14. The system of claim 1, wherein the at least one sensor is coupled to the classifier by a wired interface.

15. The system of claim 1, wherein the sensor and the classifier are integrated into the same device.

16. The system of claim 1, wherein the sensor and the classifier are integrated into the same package.

17. The system of claim 1, wherein the sensor and the classifier are integrated into the same chip.

18. The system of claim 1, wherein the sensor comprises at least one sensor selected from the group consisting of an accelerometer, a gyroscope, a pressure sensor, a microphone, and a magnetometer.

19. The system of claim 1, wherein the pattern of data corresponds to an activity selected from the group consisting of walking, running, biking, swimming, rowing, skiing, stationary exercising and driving.

20. A method for recognizing a first activity comprising:
obtaining data from at least one sensor associated with a user;
performing a classification routine to identify a first pattern of data obtained from the at least one sensor as corresponding to the first activity; and
modifying the classification routine based, at least in part, on received information.

21. The activity recognition method of claim 20, wherein the classification routine employs a database configured to correlate sensor data with the first activity.

22. The activity recognition method of claim 20, wherein the classification routine employs an algorithm configured to identify the first activity based, at least in part, on the first pattern of data.

23. The activity recognition method of claim 20, wherein the classification routine is modified using data output by the at least one sensor.

24. The activity recognition method of claim 20 wherein the classification routine is modified using information from an external source.

25. The method of claim 20, wherein the first activity comprises an existing activity.

26. The method of claim 20, wherein the first activity comprises a new activity.

27. The method of claim 20, further comprising comparing the sensor data to a confidence threshold, wherein the classification routine is modified based, at least in part, on the comparison.

28. The method of claim 20, wherein the classification routine is modified by data output by the at least one sensor based, at least in part, on a user input.

29. The method of claim 21, wherein the database is maintained remotely, further comprising uploading sensor data to a server.

30. The method of claim 29, further comprising aggregating data from multiple users in the database.

31. The method of claim 21, further comprising maintaining the database locally.

32. The method of claim 20, further comprising coupling the at least one sensor to a device configured to perform the classification routine with a wireless interface.

33. The method of claim 20, further comprising coupling the at least one sensor to a device configured to perform the classification routine with a wired interface.

34. The method of claim 20, wherein the sensor comprises at least one sensor selected from the group consisting of an accelerometer, a gyroscope, a pressure sensor, a microphone, and a magnetometer.

35. The method of claim 20, wherein the pattern of data corresponds to an activity selected from the group consisting of walking, running, biking, swimming, rowing, skiing, stationary exercising and driving.
